(19) United States
(12) Patent Application Publication
(10) Pub. No.: US 2015/0128024 A1
(43) Pub. Date: May 7, 2015

(54) SYSTEM AND METHOD FOR MATCHING CONTENT TO MULTIMEDIA CONTENT RESPECTIVE OF ANALYSIS OF USER VARIABLES

(71) Applicant: CORTICA, LTD., Ramat Gan (IL)

(72) Inventors: Igal Raichelgauz, New York, NY (US); Karina Odinaev, New York, NY (US); Yehoshua Y. Zeevi, Haifa (IL)

(73) Assignee: CORTICA, LTD., RAMAT GAN (IL)

(21) Appl. No.: 14/596,605

(22) Filed: Jan. 14, 2015

Related U.S. Application Data
(63) Continuation-in-part of application No. 13/624,397, filed on Sep. 21, 2012.
Application No. 13/624,397 is a continuation-in-part of application No. 13/344,400, filed on Jan. 5, 2012, now Pat. No. 8,959,037.
Application No. 13/344,400 is a continuation of application No. 12/434,221, filed on May 1, 2009, now Pat. No. 8,112,376.
Application No. 12/434,221 is a continuation-in-part of application No. 12/195,863, filed on Aug. 21, 2008, now Pat. No. 8,326,775.
Application No. 12/195,863 is a continuation-in-part of application No. 12/084,150, filed on Apr. 7, 2009, now Pat. No. 8,655,801.
Application No. 13/624,397 is a continuation-in-part of application No. 12/195,863, filed on Aug. 21, 2008, now Pat. No. 8,326,775.
Application No. 12/195,863 is a continuation-in-part of application No. 12/084,150, filed on Apr. 7, 2009, now Pat. No. 8,655,801.
Application No. 13/624,397 is a continuation-in-part of application No. 12/084,150, filed on Apr. 7, 2009, now Pat. No. 8,655,801.
(60) Provisional application No. 61/928,461, filed on Jan. 17, 2014.

(30) Foreign Application Priority Data
Oct. 26, 2005 (IL) 171577
Jan. 29, 2006 (IL) 173409
Aug. 21, 2007 (IL) 185414

(51) Int. Cl. G06F 17/22; G06F 3/0487; G06Q 30/02; G06F 17/30

(52) U.S. Cl. CPC G06F 17/2247; G06F 17/30386; G06F 3/0487; G06Q 30/0241
USPC 715/234

(57) ABSTRACT

A system and method for matching content to a multimedia content element are provide. The method includes receiving a request to display a webpage on a user node; receiving at least one personal variable related to a user of the user node; extracting at least one multimedia content element from the webpage; generating, by a signature generator system, a signature for each multimedia content element of the at least one multimedia content element; searching for at least one content item based on each signature and the at least one personal variable; and causing the display on the user node of the at least one content item within a display area of the webpage.

### CROSS-REFERENCE TO RELATED APPLICATIONS

This application claims the benefit of U.S. Provisional Application No. 61/928,461 filed on Jan. 17, 2014. This application is also a continuation-in-part (CIP) of U.S. patent application Ser. No. 13/624,397 filed on Sep. 21, 2012, now pending, which is a CIP of:
(a) U.S. patent application Ser. No. 13/344,400 filed on Jan. 5, 2012, now allowed, which is a continuation of U.S. patent application Ser. No. 12/434,221, filed on May 1, 2009, now U.S. Pat. No. 8,112,376. The Ser. No. 13/344,400 application is also a CIP of the below referenced U.S. patent application Ser. No. 12/195,863 and the below-referenced U.S. patent application Ser. No. 12/084,150;
(b) U.S. patent application Ser. No. 12/195,863, filed on Aug. 21, 2008, now U.S. Pat. No. 8,326,775, which claims priority under 35 USC 119 from Israeli Application No. 185414 filed on Aug. 21, 2007, and which is also a continuation-in-part of the below-referenced U.S. patent application Ser. No. 12/084,150; and
(c) U.S. patent application Ser. No. 12/084,150 filed on Apr. 7, 2009, now U.S. Pat. No. 8,655,801, which is the National Stage of International Application No. PCT/IL2006/001235 filed on Oct. 26, 2006, which claims foreign priority from Israeli Application No. 171577 filed on Oct. 26, 2005 and Israeli Application No. 173409 filed on Jan. 29, 2006.

All of the applications referenced above are herein incorporated by reference for all that they contain.

### TECHNICAL FIELD

The present invention relates generally to the analysis of multimedia content, and more specifically to a system for matching relevant content to the analyzed multimedia content to be displayed as part of a webpage on a user's display respective of personal variables of a user.

### BACKGROUND

With the abundance of data made available through various means in general and the Internet and world-wide web (WWW) in particular, understanding likes and dislikes of users has become essential for online businesses.

Prior art solutions provide several tools to identify users' preferences. Some prior art solutions actively require an input from the users to specify their interests. However, profiles generated for users based on their inputs may be inaccurate as the users tend to provide only their current interests, or only partial information due to their privacy concerns.

In cases where the user has found content he likes through the web, the task of finding similar content can be quite complex, as the user may not know which queries to use. For example, when a user is viewing an image of an unfamiliar landscape and no further description is available, the user may not be able identify the location of the landscape or find images of the same location via a keyword search.

It would therefore be advantageous to provide a solution that would overcome the deficiencies of the prior art by matching relevant content to existing multimedia elements.

### SUMMARY

A summary of several example aspects of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all aspects nor delineate the scope of any or all aspects. Its sole purpose is to present some concepts of one or more embodiments in a simplified form as a prelude to the more detailed description that is presented later. For convenience, the term some embodiments may be used herein to refer to a single embodiment or multiple embodiments of the disclosure.

Certain embodiments disclosed herein include a method for matching content to a multimedia content element. The method comprises receiving a request to display a webpage on a user node; receiving at least one personal variable related to a user of the user node; extracting at least one multimedia content element from the webpage; generating a signature for each multimedia content element of the at least one multimedia content element; searching for at least one content item based on each signature and the at least one personal variable; and causing the display on the user node of the at least one content item within a display area of the webpage.

Certain embodiments disclosed herein also include a system for matching content to a multimedia content element. The system comprises a signature generator system; a processor; and a memory, the memory containing instructions that, when executed by the processor, configures the system to: receive a request to display a webpage on a user node; receive at least one personal variable related to a user of the user node; extract at least one multimedia content element from the webpage; generate a signature for each multimedia content element of the at least one multimedia content element; search for at least one content item based on each signature and the at least one personal variable; and cause the display on the user node of the at least one content item within a display area of the webpage.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic block diagram of a system for processing multimedia content displayed on a webpage according to an embodiment.

FIG. 2 is a block diagram depicting the basic flow of information in the signature generator system.

FIG. 3 is a diagram showing the flow of patches generation, response vector generation, and signature generation in a large-scale speech-to-text system.

FIG. 4 is a flowchart describing the process of matching content items to multimedia content displayed on a webpage according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

Certain exemplary embodiments disclosed herein allow matching at least an appropriate content item that is relevant to a certain user of a user node to multimedia content displayed on a webpage respective of personal variables of the user, and analyzing the multimedia content displayed on the webpage accordingly. Based on the analysis results, for one or more multimedia content elements included in the webpage, one or more matching signatures are generated. The signatures are utilized to search for appropriate advertisement(s) in a data warehouse to be displayed in the webpage. Content related to the user node is selected based on one or more personal variables related to the user of the user node and/or to the user node itself. Such personal variables may be, for example, tracking information gathered with respect to the user of the user node, demographic information related to the user of the user node, a search history stored in a memory unit of the user node, a combination thereof, and the like.

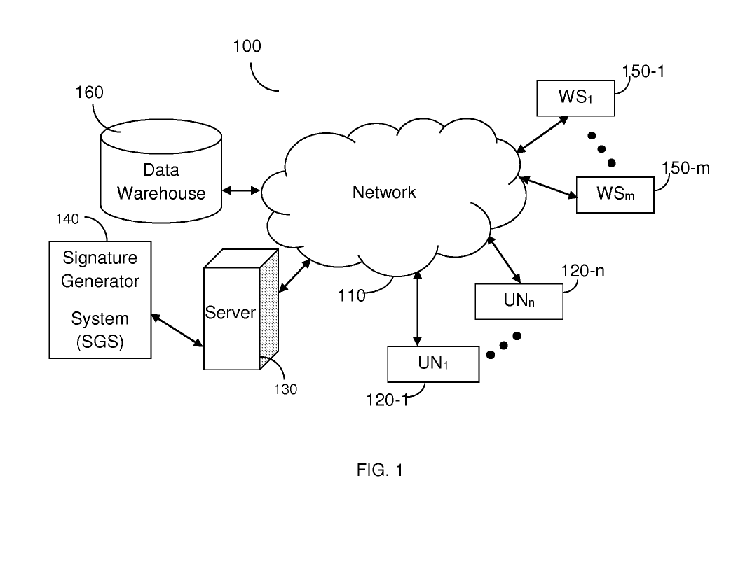

FIG. 1 shows an exemplary and non-limiting schematic diagram of a system 100 for providing content items related to multimedia content displayed in a webpage in accordance with one embodiment. A network 110 is used to communicate between different parts of the system. The network 110 may be the Internet, the world-wide-web (WWW), a local area network (LAN), a wide area network (WAN), a metro area network (MAN), and other networks capable of enabling communication between the elements of the system 100.

Further connected to the network 110 are one or more user nodes 120, such as user nodes (UNs) 120-1 through 120-n (collectively referred to hereinafter as user nodes 120 or individually as a user node 120, merely for simplicity purposes). The user node 120 may have a web browser installed therein. The user node 120 may be, for example, a personal computer (PC), a personal digital assistant (PDA), a wearable computing device, a mobile phone, a tablet computer, and other kinds of wired and mobile appliances equipped with browsing, viewing, listening, filtering, managing capabilities, and the like, that are enabled as further discussed herein below.

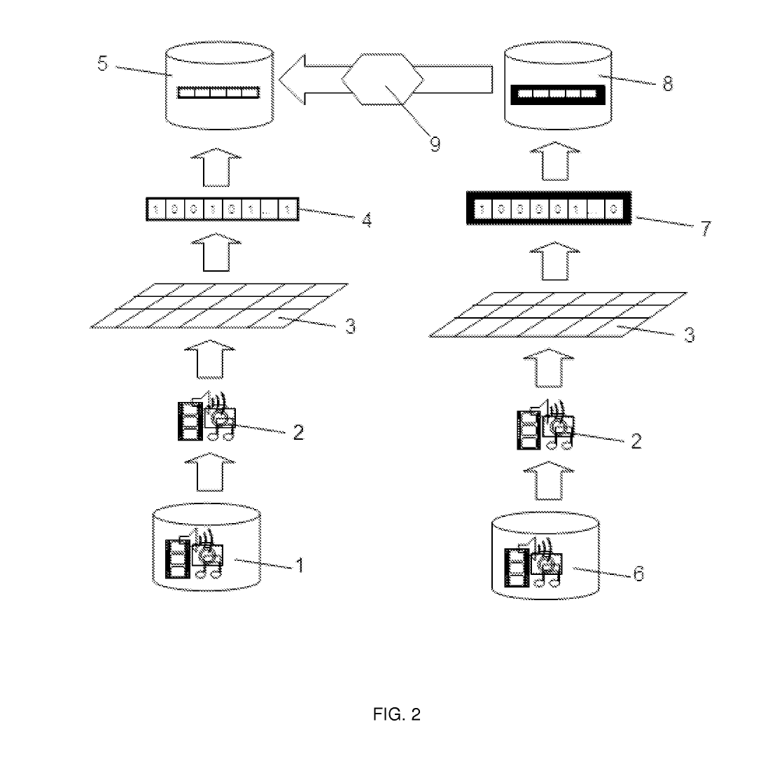

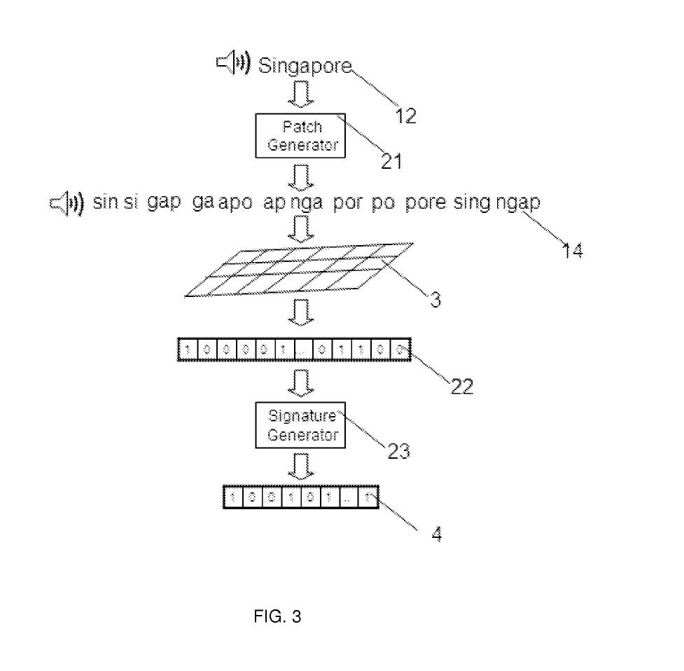

A server 130 is further connected to the network 110 and may provide to a web browser installed on the user node 120 webpages containing multimedia content, or references therein, such that, upon request by a web browser, such webpages and/or multimedia content are provided to the user node 120. The system 100 also includes a signature generator system (SGS) 140. In one embodiment, the SGS 140 is connected to the server 130. The server 130 is enabled to receive and serve multimedia content and causes the SGS 140 to generate a signature respective of the multimedia content. The process for generating the signatures of multimedia content is explained in more detail herein below with respect to FIGS. 2 and 3. The various elements of the system 100 as depicted in FIG. 1 are also described in the above-referenced co-pending U.S. patent application Ser. No. 13/344,400 (hereinafter the “'400 application”) to Raichelgauz, et al., which is assigned to common assignee, and is hereby incorporated by reference for all that it contains.

The server 130 is further configured to receive one or more personal parameters related to the user and/or to the user node 120. According to one embodiment, the user activity through the network 110 is monitored by the server 130 and one or more personal variables are generated respective thereto. The generated signatures and the personal variables are used by the server 130 in order to search for related content items through a plurality of web sources 150-1 through 150-m (collectively referred to hereinafter as web sources 150 or individually as a web source 150, merely for simplicity purposes) which are also connected to the network 110.

It should be noted that each of the server 130 and the SGS 140 typically comprises a processing unit, such as a processor (not shown) that is coupled to a memory (not shown). The memory contains instructions that can be executed by the processing unit. The instructions, when executed by the processing unit, cause the processing unit to perform the various functions described herein. The one or more processors may be implemented with any combination of general-purpose microprocessors, multi-core processors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information. The server 130 also includes an interface (not shown) to the network 110. In one embodiment, the selected content items, personal variables, and the generated signatures may be stored in a data warehouse 160 which is connected to the server 130 (either directly or through the network 110) for future requests for multimedia content.

According to the embodiments disclosed herein, a user visits a webpage using a web browser of the user node 120. When the webpage is uploaded on the web browser of the user node 120, a request is sent to the server 130 to analyze the multimedia content contained in the webpage. In an embodiment, a request is sent responsive to a gesture of the user on the user node 120. The user's gesture may be: a scroll on the multimedia content element, a press on the multimedia content element, a click on the multimedia content element, a tap on the multimedia content element, and/or a response to the multimedia content. This gesture-based response ensures that the user wishes to receive content items related to that multimedia content element. The request to analyze the multimedia content may include a URL of the webpage or a copy of the webpage. In one embodiment, the request may include multimedia content elements extracted from the webpage. A multimedia content element may include, for example, an image, a graphic, a video stream, a video clip, an audio stream, an audio clip, a video frame, a photograph, an image of signals (e.g., spectrograms, phasograms, scalograms, etc.), and/or combinations thereof and portions thereof.

The server 130 is configured to analyze the multimedia content elements in the webpage and the one or more personal variables to detect one or matching advertisements for the multimedia content elements. It should be noted that the server 130 may analyze all or a subset of the multimedia content elements contained in the webpage and all of the personal variables or a portion thereof. It should be further noted that the number of related content items that are provided in response to the analysis may be determined based on the number of content items that can be displayed on the webpage or may be pre-configured by the server 130. The SGS 140 generates for each multimedia content element provided by the server 130 at least one signature. The generated signature(s) may be robust to noise and distribution as discussed below. Then, using the generated signature(s) and the one or more personal variables, the server 130 searches the data warehouse 160 for related content. Such content may be advertising, web articles, webpages, and the like. For example, if the signature of an image indicates a “Guitar” and the user node 120 is identified as located in the United States, then an English article teaching how to play a guitar is potentially related. Advertising for guitar lessons within a pre-specified distance of the user's location is also potentially related.

It should be noted that using signatures together with personal variables related to the user node 120 for searching of content items ensures more accurate reorganization of multimedia content than, for example, using metadata. For instance, certain content is not appropriate for children and, therefore, identification of the age of the user using the user node 120 is desirable.

In one embodiment, the signatures generated for more than one multimedia content element are clustered. The clustered signatures are used to search for a matching advertisement. The one or more selected matching advertisements are retrieved from the data warehouse 160 and uploaded to the webpage on the web browser of the user node 120 by means of one of the web sources 150.

The retrieved content may be immediately displayed on the display of the user node 120. In an embodiment, the retrieved content may be displayed responsive to a user's gesture. The user's gesture may be: a scroll on the multimedia content element, a press on the multimedia content element, a click on the multimedia content element, a tap on the multimedia content element, and/or a response to the multimedia content. This gesture-based response ensures that the user wishes to receive content items related to that multimedia content element. According to another embodiment, different types of gestures may indicate different types of content the user wishes to receive. For example, a press on the multimedia content element may indicate that the user wishes to receive content that matches the signatures of the multimedia content element, while a scroll over the multimedia content element may indicate that the user does not wish to receive content that relates to the signatures of the multimedia content element.

FIGS. 2 and 3 illustrate the generation of signatures for the multimedia content elements by the SGS 140 according to one embodiment. An exemplary high-level description of the process for large scale matching is depicted in FIG. 2. In this non-limiting example, the matching is for a video content.

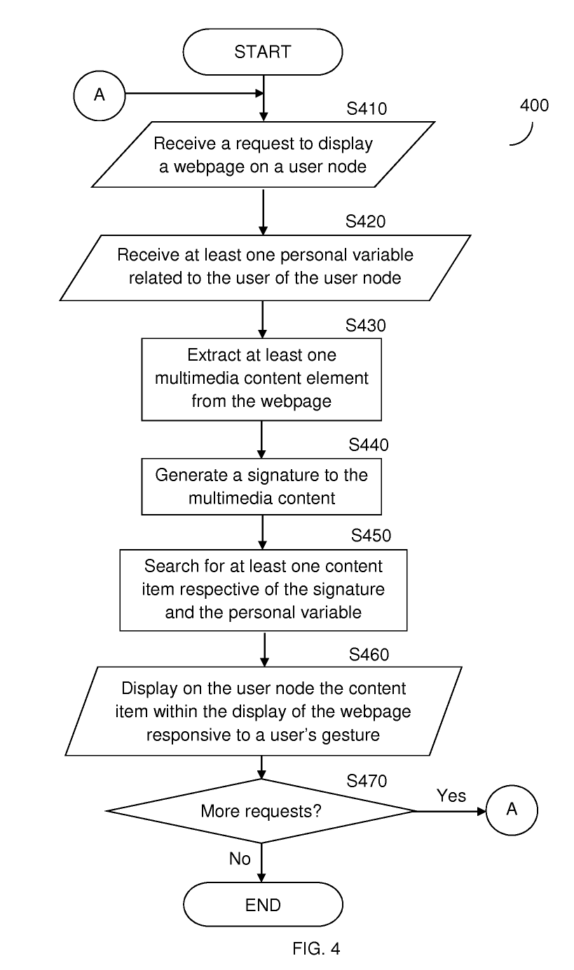

Video content segments 2 from a Master database (DB) 6 and a Target DB 1 are processed in parallel by a large number of independent computational cores 3 that constitute an architecture for generating the signatures (hereinafter the “Architecture”). Further details on the computational cores generation are provided below. The independent cores 3 generate a database of Robust Signatures and Signatures 4 for Target content-segments 5 and a database of Robust Signatures and Signatures 7 for Master content-segments 8. An exemplary and non-limiting process of signature generation for an audio component is shown in detail in FIG. 4. Finally, Target Robust Signatures and/or Signatures are effectively matched, by a matching algorithm 9, to Master Robust Signatures and/or Signatures database to find all matches between the two databases.

To demonstrate an example of signature generation process, it is assumed, merely for the sake of simplicity and without limitation on the generality of the disclosed embodiments, that the signatures are based on a single frame, leading to certain simplification of the computational cores generation. The Matching System is extensible for signatures generation capturing the dynamics in between the frames.

The signatures' generation process will now be described with reference to FIG. 3. The first step in the process of signatures generation from a given speech-segment is to breakdown the speech-segment to K patches 14 of random length P and random position within the speech segment 12. The breakdown is performed by the patch generator component 21. The value of the number of patches K, random length P and random position parameters is determined based on optimization, considering the tradeoff between accuracy rate and the number of fast matches required in the flow process of the server 130 and SGS 140. Thereafter, all the K patches are injected in parallel into all computational cores 3 to generate K response vectors 22, which are fed into a signature generator system 23 to produce a database of Robust Signatures and Signatures 4.

In order to generate Robust Signatures, i.e., signatures that are robust to additive noise L (where L is an integer equal to or greater than 1) by the computational cores 3, a frame ‘i’ is injected into all the cores 3. Then, cores 3 generate two binary response vectors: \vec{S} which is a Signature vector, and \vec{RS} which is a Robust Signature vector.

For generation of signatures robust to additive noise, such as White-Gaussian-Noise, scratch, etc., but not robust to distortions, such as crop, shift and rotation, etc., a core Cᵢ={nᵢ} (1≦i≦L) may consist of a single leaky integrate-to-threshold unit (LTU) node or more nodes. The node nᵢ equations are:

$${V}_{i} = {\sum }_{j} {w}_{ij} {k}_{j}$$

$${n}_{i} = ( Vi - {Th}_{x} )$$

where, is a Heaviside step function; wᵢⱼ is a coupling node unit (CNU) between node i and image component j (for example, grayscale value of a certain pixel j); kⱼ is an image component ‘j’ (for example, grayscale value of a certain pixel j); Thₓ is a constant threshold value, where x is ‘S’ for Signature and ‘RS’ for Robust Signature; and Vi is a Coupling Node Value.

The threshold values Thx are set differently for signature generation and for Robust Signature generation. For example, for a certain distribution of Vi values (for the set of nodes), the thresholds for Signature (ThS) and Robust Signature (Th_{RS}) are set apart, after optimization, according to at least one or more of the following criteria:
1: For: Vᵢ>Th_{RS}

1−p(V>Th_{S})−1−(1−ε)^{l}<<1

i.e., given that l nodes (cores) constitute a Robust Signature of a certain image I, the probability that not all of these I nodes will belong to the Signature of same, but noisy image, Ĩ is sufficiently low (according to a system's specified accuracy).
2: p(Vᵢ>Th_{RS})≈l/L
   i.e., approximately l out of the total L nodes can be found to generate a Robust Signature according to the above definition.
3: Both Robust Signature and Signature are generated for certain frame i.

It should be understood that the generation of a signature is unidirectional, and typically yields lossless compression, where the characteristics of the compressed data are maintained but the uncompressed data cannot be reconstructed. Therefore, a signature can be used for the purpose of comparison to another signature without the need of comparison to the original data. The detailed description of the signature generation is discussed in more detail in the co-pending and allowed patent applications of which this patent application is a continuation-in-part, and are hereby incorporated by reference.

A computational core generation is a process of definition, selection, and tuning of the parameters of the cores for a certain realization in a specific system and application. The process is based on several design considerations, such as:
(a) The cores should be designed so as to obtain maximal independence, i.e., the projection from a signal space should generate a maximal pair-wise distance between any two cores' projections into a high-dimensional space.
(b) The cores should be optimally designed for the type of signals, i.e., the cores should be maximally sensitive to the spatio-temporal structure of the injected signal, for example, and in particular, sensitive to local correlations in time and space. Thus, in some cases a core represents a dynamic system, such as in state space, phase space, edge of chaos, etc., which is uniquely used herein to exploit their maximal computational power.
(c) The cores should be optimally designed with regard to invariance to a set of signal distortions, of interest in relevant applications.

A detailed description of the computational core generation and the process for configuring such cores is discussed in more detail in the above-referenced U.S. Pat. No. 8,655,801.

FIG. 4 depicts an exemplary and non-limiting flowchart 400 describing the process of matching content items to multimedia content displayed on a webpage according to an embodiment. In S410, a request to upload a webpage to a web browser of a user device (e.g., the user node 120-1) is received. In an embodiment, the method may begin responsive to a gesture of the user. The user's gesture may be: a scroll on the multimedia content element, a press on the multimedia content element, a click on the multimedia content element, a tap on the multimedia content element, and/or a response to the multimedia content. This gesture-based response ensures that the user wishes to receive content items related to that multimedia content element.

In S420, at least one personal variable related to the user of the user node 120-1 or to the user node 120-1 is received. A personal variable may be, for example, tracking information gathered with respect to the user of the user node, demographic information related to the user of the user node, a search history stored in a memory unit of the user node, a combination thereof, and so on. In S430, at least one multimedia content element is extracted from the webpage.

In S440, a signature is generated respective of the multimedia content element. The signature for the multimedia content element may be generated by a SGS (e.g., the SGS 140) as described herein above with respect to FIGS. 2 and 3. In S450, a search for at least one content item related to both the signature and the at least one personal variable is performed. In an embodiment, the search is performed through the plurality of web sources 150. A content item may be related to a generated signature and to a personal variable if, for example, signature matching between a signature associated with the content item, the generated signature, and a signature of the personal variable exceeds a predefined threshold.

In S460, the content item is displayed within the display of the webpage. According to another embodiment, the content item is displayed responsive to a user's gesture received from the user device. The user's gesture may be: a scroll on the multimedia content element, a press on the multimedia content element, a click on the multimedia content element, a tap on the multimedia content element, and/or a response to the multimedia content. This gesture-based response ensures that the user wishes to receive content items related to that multimedia content element. According to another embodiment, different types of gestures may indicate different types of content the user wishes to receive. For example, a press on the multimedia content element may indicate that the user wishes to receive content that matches the signatures of the multimedia content element while a scroll over the multimedia content element may indicate that the user does not wish to receive content that relates to the signatures of the multimedia content element.

In S470, it is checked whether there are additional webpages requested and, if so, execution continues with S410; otherwise, execution terminates.

The requested webpage(s) may contain a number of multimedia content elements; however, in some instances only a few content items may be displayed in the webpage. Accordingly, in one embodiment, the signatures generated for the multimedia content elements are clustered and the cluster of signatures is matched to one or more content items.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiments and the concepts contributed by the inventor to furthering the art, and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for matching content items to a multimedia content element, comprising:
receiving a request to display a webpage on a user node;
receiving at least one personal variable related to a user of the user node;
extracting at least one multimedia content element from the webpage;
generating a signature for each multimedia content element of the at least one multimedia content element;
searching for at least one content item based on each signature and the at least one personal variable; and
causing the display on the user node of the at least one content item within a display area of the webpage.

2. The method of claim 1, wherein the at least one content item is displayed within the display area of the webpage when a gesture of the user is detected by the user node.

3. The method of claim 2, wherein the user gesture is any one of: a scroll over the at least one multimedia content element, a press on the at least one multimedia content element, a click on the at least one multimedia content element, a tap on the at least one multimedia content element, and a response to the at least one multimedia content element.

4. The method of claim 1, wherein the request is received responsive to a gesture of the user of the user node.

5. The method of claim 4, wherein the user gesture is any one of: a scroll over the at least one multimedia element, a press on the multimedia content element, a click on the at least one multimedia element, a tap on the at least one multimedia element, and a response to the at least one multimedia element.

6. The method of claim 1, wherein the personal variable is at least one of: tracking information gathered with respect of the user of the user node, demographic information related to the user, and a search history of the user.

7. The method of claim 1, wherein each signature is robust to noise and distortions.

8. The method of claim 1, wherein the multimedia content element is at least one of: an image, graphics, a video stream, a video clip, an audio stream, an audio clip, a video frame, a photograph, images of signals, and a portion thereof.

9. A non-transitory computer readable medium having stored thereon instructions for causing one or more processing units to execute the method according to claim 1.

10. A system for matching content to a multimedia content element, comprising:
an interface to a network for receiving a request to display a webpage on a user node;
a processor communicatively connected to a network;
a signature generator system; and
a memory connected to the processor, the memory containing instructions that, when executed by the processor, configure the system to:
receive a request to display a webpage on a user node;
receive at least one personal variable related to a user of the user node;
extract at least one multimedia content element from the webpage;
generate a signature for each multimedia content element of the at least one multimedia content element;
search for at least one content item based on each signature and the at least one personal variable; and
cause the display on the user node of the at least one content item within a display area of the webpage.

11. The system of claim 10, wherein the at least one advertisement item is displayed within a display area the webpage upon detection of a gesture of the user of the user node.

12. The system of claim 11, wherein the user gesture is any one of: a scroll over the at least one multimedia content element, a press on the at least one multimedia content element, a click on the at least one multimedia content element, a tap on the at least one multimedia content element, and a response to the at least one multimedia content element.

13. The system of claim 10, wherein the request is received responsive to a gesture of the user of the user node.

14. The system of claim 13, wherein the user gesture is any one of: a scroll over the at least one multimedia content element, a press on the at least one multimedia content element, a click on the at least one multimedia content element, a tap on the at least one multimedia content element, and a response to the at least one multimedia content element.

15. The system of claim, 10 wherein the personal variable is at least one of: tracking information gathered with respect of the user of the user node, demographic information related to the user, and a search history stored of the user.

16. The system of claim 10, wherein the at least one signature is robust to noise and distortions.

17. The system of claim 10, wherein the multimedia content element is at least one of: an image, graphics, a video stream, a video clip, an audio stream, an audio clip, a video frame, a photograph, images of signals, combinations thereof, and portions thereof.
